(19) United States
(12) Patent Application Publication
(10) Pub. No.: US 2022/0017330 A1
(43) Pub. Date: Jan. 20, 2022

(54) ELEVATOR SAFETY CIRCUIT

(71) Applicant: Otis Elevator Company, Farmington, CT (US)

(72) Inventors: Peter Herkel, Berlin (DE); Jan Ruhnke, Berlin (DE)

(21) Appl. No.: 17/373,995

(22) Filed: Jul. 13, 2021

(30) Foreign Application Priority Data
Jul. 16, 2020 (EP) 20186287.7

(51) Int. Cl. B66B 5/00; B66B 1/32; B66B 5/02

(52) U.S. Cl. CPC B66B 5/0093; B66B 5/02; B66B 1/32

(57) ABSTRACT

An elevator safety circuit for an elevator system in which an output is arranged to selectively provide an electrical current from an input to an electromagnetic brake coil via a current flow path. An actuator transistor is arranged in series along the current flow path between the input and the output, the actuator transistor being arranged to selectively allow passage of the electrical current. A controller is arranged to carry out a test operation when the braking element is in the open position. The test operation comprises operating the actuator transistor in its disabled mode for a time period, monitoring the electrical current through the brake coil, and determining whether the magnitude of the electrical current reduces during said time period, the time period being selected such that the magnitude of the electrical current remains sufficient for keeping the braking element in the open position during the test.

### FOREIGN PRIORITY

This application claims priority to European Patent Application No. 20186287.7, filed Jul. 16, 2020, and all the benefits accruing therefrom under 35 U.S.C. § 119, the contents of which in its entirety are herein incorporated by reference.

### TECHNICAL FIELD

This disclosure relates to an elevator safety circuit, and particularly to mechanisms for testing the ability of the safety circuit to operate a brake within an elevator system.

### BACKGROUND

Elevator systems are generally provided with one or more braking systems that, when activated, prevent movement of the elevator car within the hoistway. One of the primary forms of braking provided within an elevator is the ‘machine brake’, which is generally located within or proximate to the elevator drive. This machine brake acts to oppose driving of the elevator, i.e. to slow and/or stop motion of the elevator car with the hoistway.

Typically, the machine brake is an electromagnet-based device. When the electromagnet is engaged (i.e. when the coil of the electromagnet is supplied with a current), the electromagnet separates the frictional brake mechanism (e.g. brake pads or discs) from the rotating part of the motor. Conversely, when the electromagnet is not engaged (i.e. when the power is off), the electromagnetic force disappears and the brake contacts the rotating part of the motor, applying friction and preventing rotation of the motor. Generally, a spring force acts to bias the brake to the closed position (i.e. to prevent motor rotation), where this spring force is overcome by the electromagnetic force when the electromagnet is engaged (i.e. when motion of the elevator is desired).

The engagement or disengagement of the electromagnet for normal operation is generally controlled by a drive switch connected in series between the drive and the brake coil. By closing or opening the drive switch, the current is passed from the drive through the brake coil or not, respectively.

Generally, conventional elevator systems, known in the art per se, include a ‘safety chain’ that prevents current flowing through the brake coil unless the safety of the elevator is assured, regardless of the state of the drive switch. This safety chain is formed from a series connection of physical switches including, for example, physical door switches and limit switches. Each switch in the chain must be closed in order for current to flow through the safety chain.

Rather than being directly situated between the power supply and the brake coil, the safety chain is typically coupled to ‘actuators’ positioned between the power supply and the brake coil, usually in series. These actuators are generally in series with, and ‘downstream’ of, the drive switch. Typically, two actuators are used as a series pair to provide redundancy, in case of failure of one of them. Each of these actuators acts like a switch and is arranged such that if current is not flowing through the safety chain—i.e. if one or more of the conditions monitored by the switches in the safety chain is not satisfied—the actuator switches ‘open’, thereby preventing current from flowing from the supply to the brake coil.

The actuators, together with any other related components connected between the supply and the brake coil may be referred to as a ‘safety circuit’, where operation of the safety circuit may be controlled by the safety chain.

Thus these actuators, together with the safety chain, provide for safety operation. Specifically, the opening of any ‘link’ in the safety chain (i.e. any safety chain switch) causes the actuators in the safety circuit to open, thereby opening the safety circuit and preventing current flow through the brake coil. The conditions that cause this behaviour may be selected in accordance with safety requirements but may, for example, include the elevator car's travel speed exceeding a threshold limit, a detected malfunction of a system component, or in response to a manual command, where each of these conditions is monitored by a switch in the safety chain.

Thus if a fault is detected, the safety chain ‘breaks’ (i.e. one or more of the switches in the safety chain opens) and the actuators in the safety circuit are opened as a result, preventing motion of the elevator car by removing the brake coil current, where a reduction/elimination of the current leads to the brake pads engaging the motor.

Given the safety-critical nature of these safety actuators, it is generally important to test these regularly to ensure that the safety chain can operate the brake as-andwhen it is necessary to do so.

In conventional elevator systems, known in the art per se, the safety actuators are generally constructed from relays. These relays are generally arranged with their contact terminals in series between the supply and the brake coil. The input terminals of the relays (i.e. the connections to the respective relays' coils) are connected in parallel, each input terminal being independently connected to the ‘end’ of the safety chain.

In order to test these relays are operational, conventional tests may be conducted using the back contacts of the relays when the elevator car is at a standstill, i.e. when it is not moving. However, relays can be noisy when testing.

An alternative to using relays for these ‘safety actuators’ is to use electronic switches, e.g. transistors. These may effectively eliminate the noise issue associated with relays. However, the use of transistors as these safety actuators means that they can only be tested when the elevator is in motion, because testing the switching behaviour of a transistor necessitates a current passing through that transistor. Thus, with a transistor-based safety actuator system known in the art per se, the motion of the elevator car must be interrupted, which is undesirable for both performance and user experience reasons.

### SUMMARY

In accordance with a first aspect, the present disclosure provides an elevator system comprising: a brake including a braking element and an electromagnetic brake coil, said brake being arranged to pass an electrical current from a supply to the brake coil via a current flow path, said brake being arranged to apply a mechanical bias force to operate the braking element in a closed position when a magnitude of the electrical current is less than a threshold value, wherein the electromagnetic coil produces an electromagnetic force that overcomes said bias force to operate the braking element in an open position when the electrical current is equal to or greater than the threshold value; an actuator transistor arranged in series along the current flow path between the supply and the brake coil, said actuator transistor having an enabled mode in which it allows passage of the electrical current, and a disabled mode in which it interrupts the current flow path thereby preventing passage of the electrical current; and a controller arranged to carry out a test operation when the braking element is in the open position, wherein the test operation comprises operating the actuator transistor in its disabled mode for a time period, monitoring the electrical current through the brake coil, and determining whether the magnitude of the electrical current reduces during said time period; wherein the time period is selected such that the magnitude of the electrical current remains greater than the threshold current during said time period.

This first aspect of the disclosure extends to an elevator safety circuit for an elevator system, the elevator safety circuit comprising: an input arranged to receive an electrical current from a supply; an output arranged to selectively provide the electrical current to an electromagnetic brake coil via a current flow path; an actuator transistor arranged in series along the current flow path between the input and the output, said actuator transistor having an enabled mode in which it allows passage of the electrical current, and a disabled mode in which it interrupts the current flow path thereby preventing passage of the electrical current; and a controller arranged to carry out a test operation when the braking element is in the open position, wherein the test operation comprises operating the actuator transistor in its disabled mode for a time period, monitoring the electrical current through the brake coil, and determining whether the magnitude of the electrical current reduces during said time period; wherein the time period is selected such that the magnitude of the electrical current remains greater than the threshold current during said time period.

The first aspect of the disclosure also extends to a method of testing a brake in an elevator system, wherein: the brake includes a braking element and an electromagnetic brake coil, said brake being arranged to pass an electrical current from a supply to the brake coil via a current flow path, said brake being arranged to apply a mechanical bias force to operate the braking element in a closed position when a magnitude of the electrical current is less than a threshold value, wherein the electromagnetic coil produces an electromagnetic force that overcomes said bias force to operate the braking element in an open position when the electrical current is equal to or greater than the threshold value; and an actuator transistor is arranged in series along the current flow path between the supply and the brake coil, said actuator transistor having an enabled mode in which it allows passage of the electrical current, and a disabled mode in which it interrupts the current flow path thereby preventing passage of the electrical current; the method comprising: when the braking element is in the open position, operating the actuator transistor in its disabled mode for a time period; monitoring the electrical current through the brake coil; and determining whether the magnitude of the electrical current reduces during said time period; wherein the time period is selected such that the magnitude of the electrical current remains greater than the threshold current during said time period.

Thus, it will be appreciated that examples of the present disclosure provide an improved elevator system in which the elevator safety circuit utilises transistors instead of relays as the actuators that sit between the supply and the brake coil. Advantageously, the present disclosure provides an arrangement in which the operation of the safety circuit can be tested while the elevator is in motion without interrupting operation of the elevator itself The test lasts long enough to detect partial operation of the brake, without the brake being applied (i.e. without the braking element being operated in the closed position). This ‘partial stroke test’ beneficially allows the test to be carried out whenever the elevator car is in motion without fully applying the brake.

The actuator transistor may typically be of the ‘normally-off’ type, such that in the absence of a signal applied to its gate terminal, no current will flow through the actuator transistor. This provides safety benefits in that the brake will then be applied if the safety circuit were to lose power.

It will be appreciated that there are many different transistor technologies that may be used to provide switching behaviour. However, in at least some examples, the actuator transistor comprises a metal-oxide-semiconductor field-effect-transistor (MOSFET).

As outlined previously, multiple actuator transistors may be used in the safety circuit in order to provide redundancy. In some examples of the present disclosure, a plurality of actuator transistors are provided in series along the current flow path between the supply and the brake coil, wherein the controller is arranged to carry out the test operation for each of the plurality of actuator transistors sequentially.

Generally, the elevator system of the present disclosure may comprise a safety chain constructed from a plurality of switches arranged in series. These switches, which are typically physical switches, may include door switches, contact switches, limit switches, etc. in a manner well known in the art per se. The switches of the safety chain are generally arranged in series between a safety chain input and a safety chain output, such that a voltage or signal at the safety chain input is only reproduced at the safety chain output if all of the safety chain switches are closed.

The safety chain output may be coupled to the gate terminal(s) of the actuator transistor(s) such that, under normal operation, the actuator transistors are enabled when a safety chain current flows through the safety chain, and disabled when the safety chain current does not flow (i.e. when one or more of the safety chain switches is open, indicating a fault). For example, the system may comprise an optocoupler, or any suitable coupler known in the art per se, between the safety chain and the gate terminal(s) of the actuator transistor(s). The coupler may pull the voltage of the gate terminal high or low as appropriate for disabling the device type of the actuator transistor(s) as necessary, however it is generally preferred that the actuator transistor(s) are ‘active high’ devices such that pulling the gate terminal low disables the actuator transistor.

The controller may, in some examples, receive status information from the safety chain, e.g. via a controller area network (CAN) bus or any other suitable signalling system. The controller may use this status information when determining when to perform the test operation.

In a set of examples, the elevator system is arranged such that the supply is connected to the brake coil via first and second conductors, wherein the actuator transistor(s) are connected in series along the first conductor. Thus the supply may have first and second output terminals, and the brake coil may have first and second terminals, wherein the first terminal of the brake coil is connected to the first output terminal of the supply via the first conductor, and the second terminal of the brake coil is connected to the second output terminal of the supply via the second conductor. Thus, the first conductor may provide a ‘forward current path’ (i.e. to the brake coil) and the second conductor may provide a ‘return current path’ (i.e. from the brake coil).

The actuator transistor(s) may then be arranged along the ‘forward current path’, i.e. along the first conductor, in series. For example, if ‘P-channel’ MOSFET(s) are used for the actuator transistor(s), a source terminal of the actuator transistor may be connected to the supply, and a drain terminal of the actuator transistor may be connected to the brake coil. Where two actuator transistors are provided for redundancy in accordance with some examples of the present disclosure, the drain terminal of the first actuator transistor may be connected to a source terminal of the second actuator transistor, and a drain terminal of the second actuator transistor may be connected to the brake coil. Further actuator transistors could be ‘daisychained’ in this way. It will, of course, be appreciated that the connections of the ‘drain’ and ‘source’ terminals could be reversed, e.g. if an ‘N-channel’ MOSFET were used instead.

In some examples, a varistor may be connected in parallel across the brake coil. Those skilled in the art will appreciate that a varistor is a voltage-dependent resistor (VDR), which has a nonlinear, non-ohmic current-voltage characteristic in both directions of traversing current. This varistor may provide overcurrent protection to the circuit as the varistor in the shunt configuration typically does not conduct in normal operation, but if its ‘clamping voltage’ is met, it begins to conduct.

The detection of the electrical current through the brake coil may, in some examples, be monitored directly. Thus, in some examples, the controller is connected to a current monitor arranged to monitor the electrical current through the brake coil.

However, this brake coil current may be monitored indirectly, by measuring another current elsewhere in the circuit. In some examples, the controller may be connected to a current monitor arranged to monitor a current at the output of the actuator transistor(s). This current may be monitored upstream of the varistor in a set of examples where such a varistor is provided as outlined hereinabove. The current may be also be monitored upstream of a fixed resistance in a set of potentially overlapping examples where such a fixed resistance is present, which may include the fixed resistance alongside a voltage monitor, as per a set of examples outlined hereinbelow.

The indirect current monitoring may, in some potentially overlapping examples, be provided by a current monitor arranged to monitor a current on a return current path, i.e. along the second conductor as per the particular set of examples outlined previously. This current monitor may be connected downstream of the varistor and/or fixed resistance in sets of examples in which these are provided.

Additionally, or alternatively, the current through the brake coil may be monitored indirectly by monitoring a voltage across the brake coil, making use of the Ohmic relationship between the voltage and current. Thus, in some potentially overlapping examples, the controller is connected to a voltage monitor arranged to monitor a voltage across the brake coil, wherein the controller is arranged to determine the electrical current through the brake coil from said voltage. In a set of examples, a fixed resistance is connected in parallel across the brake coil. The voltage across the known resistance can be used to determine the current through that coil. This known resistance may be provided by a fixed resistor.

The current and/or voltage monitors may form part of the controller or may comprise separate, dedicated hardware. Where multiple current and/or voltage monitors are referred to, these may each be dedicated hardware units, or may be combined such that some or all such monitors, in any suitable combination, form the same hardware unit, as appropriate.

In a set of such examples, the resistance used to determine the current through the coil may be provided by a shunt resistor placed in series with a varistor (as outlined below). Additionally, or alternatively, the resistance may be placed in series along the second conductor, i.e. along the current return path.

While an AC-based electromagnet could be used with appropriate modifications to the circuit, in some examples, the supply comprises a DC power supply such that the electrical current is a direct current. Optionally, the DC power supply may supply a DC voltage of at least 10 V, e.g. at least 20 V, preferably at least 30 V, and more preferably at least 40 V. In at least some examples, the DC power supply supplies a DC voltage of 48 V. In general, DC brake coils may be preferable as they typically produce less acoustic noise than AC brake coils.

In some examples, the system may comprise a freewheel diode. This freewheel diode (sometimes referred to as a ‘flyback’ diode) may be connected between the first and second conductors, such that its anode is connected to the second conductor, and its cathode is connected to the first conductor. The freewheel diode may, at least in some examples, be connected between the supply and the actuator transistor(s), i.e. it may be ‘upstream’ of the actuator(s). This freewheel diode provides so-called ‘freewheel’ or ‘freewheeling’ behaviour, which may be required when using inductive parts, such as the brake coil.

A drive switch, which may comprise a metal-oxide-semiconductor field-effect transistor (MOSFET), may be connected between the supply and the actuator transistor(s). A control signal applied to the gate of the drive switch provides for ‘on’ and ‘off’ functions of the brake during normal operation. However, the actuator transistor(s) can cut-off the supply current from the brake coil, even if the drive switch is enabled. The control signal supplied to the drive switch may be provided by the controller—i.e. the controller that operates the actuator transistor(s)—or a further, separate controller.

The elevator system may comprise an elevator car arranged to move within a hoistway, wherein a motor provides for motion of said elevator car. The braking element may, in some examples, be arranged to frictionally engage with the motor when operated in the closed position, and to allow rotation of the motor when operated in the open position. Any given elevator car may be actuated using a plurality of such motors, and any given motor may actuate more than one elevator car. The elevator system may comprise multiple elevator cars and hoistways (where there may be a different number of each), where each may be provided with a brake and safety system as disclosed herein. The elevator car(s) may move vertically, horizontally, diagonally, or along any other suitable path, and may move between hoistways.

### BRIEF DESCRIPTION OF THE DRAWINGS

Certain examples of the present disclosure will now be described with reference to the accompanying drawings, in which:

FIG. 1 is a schematic diagram of an elevator system;

FIGS. 2A and 2B are schematic diagrams of a drive including a machine brake for use in an elevator system;

FIG. 3 is a circuit diagram of a prior art safety circuit;

FIG. 4 is a circuit diagram of a safety circuit in accordance with an example of the present disclosure;

FIG. 5 is a timing diagram illustrating partial stroke test operation of the safety circuit of FIG. 4; and

FIGS. 6A-D are circuit diagrams illustrating possible mechanisms for monitoring the current in the brake coil.

### DETAILED DESCRIPTION OF THE INVENTION

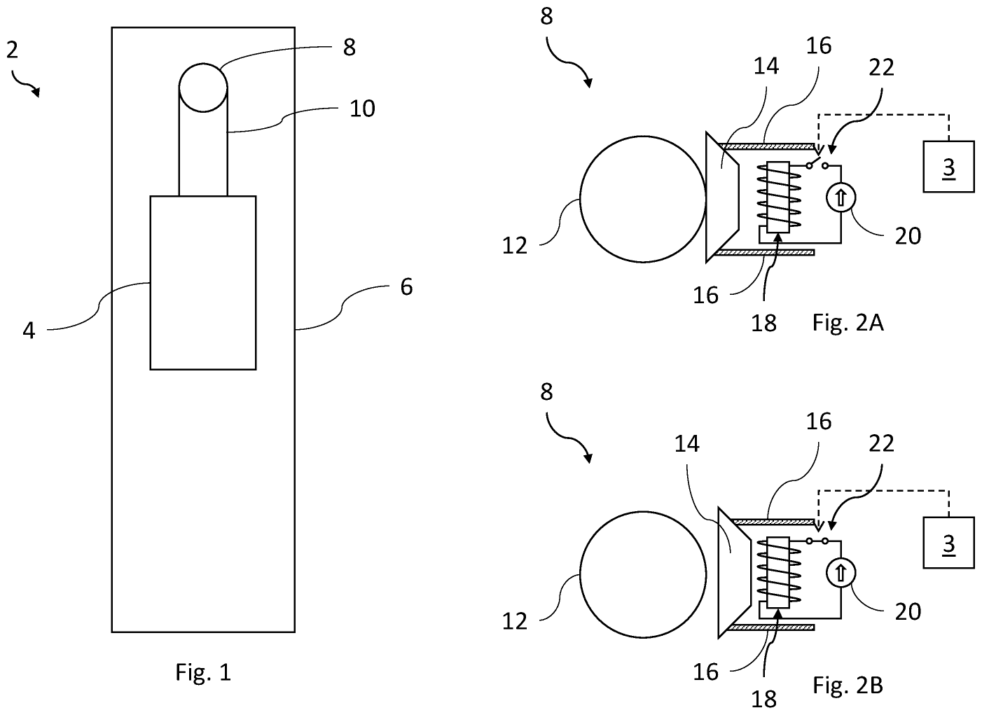

FIG. 1 is a schematic diagram of an elevator system 2, in which an elevator car 4 moves within a hoistway 6. It will be appreciated that the elevator system 2 shown in FIG. 1 is simplified for illustrative purposes and a practical elevator system may include many other parts or be constructed in a different configuration.

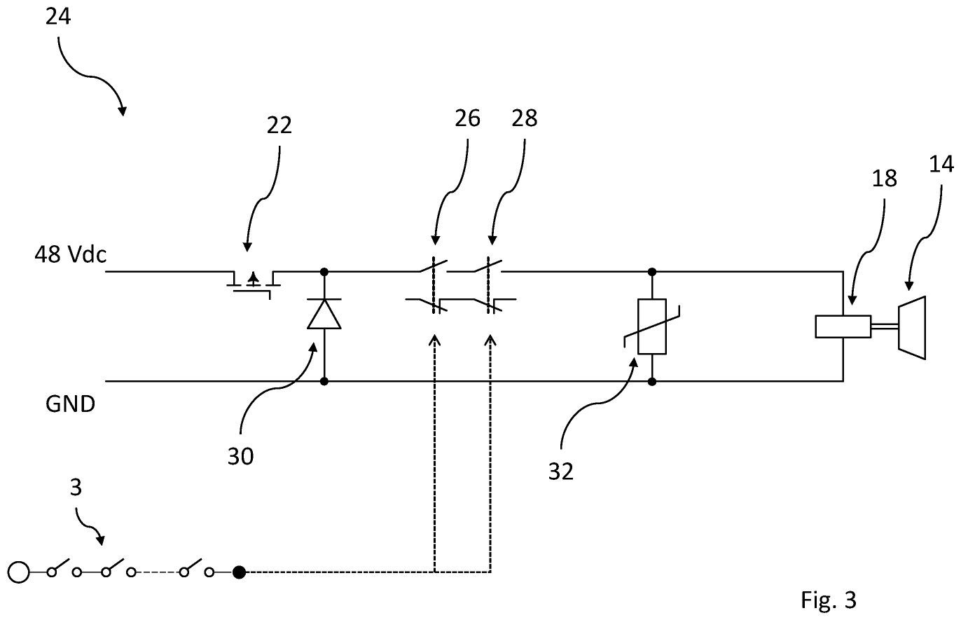

A drive 8 is arranged to drive a belt 10 (or cable or some other suitable means, known in the art per se) which drives motion, e.g. vertical motion, of the elevator car 4 within the hoistway 6. Elements of the drive can be seen in more detail in FIGS. 2A and 2B.

FIGS. 2A and 2B are schematic diagrams of a drive 8 including a machine brake for use in an elevator system, where FIG. 2A shows the brake in its ‘open’ position and FIG. 2B shows the brake in its ‘closed’ position, as outlined in further detail below.

The drive 8 includes a motor 12 and a braking element 14, in this case a brake pad, that can come into frictional contact with the motor 12 to slow or stop the motor 12. This braking element 14 is biased to the closed position by resilient members, in this case springs 16. These springs apply a mechanical biasing spring force to the braking element 14 to ‘push’ it into contact with the motor 12, as shown in FIG. 2A.

This spring force can be overcome by an electromagnetic force that is selectively provided by an electromagnet formed by a brake coil 18, i.e. an electromagnet coil. A supply current 20, e.g. a direct current, can be passed through the brake coil 18, which induces a magnetic field surrounding the coil 18 in a manner well known in the art per se. This current 20 can selectively be supplied by opening or closing a ‘drive’ switch 22 to break or make a complete circuit that provides a current flow path through the brake coil 18.

As can be seen in FIG. 2B, when the drive switch 22 is closed, the supply current 20 flows through the brake coil 18, inducing the magnetic field. Provided the supply current is sufficiently large, the resulting electromagnetic force overcomes the 30 spring force from the springs 16, pulling the braking element 14 away from the motor 12, allowing the motor 12 to rotate freely.

The ‘normally closed’ behaviour of the brake ensures that the brake operates if power is interrupted, for safety purposes.

Generally, the elevator system 2 is provided with a ‘safety chain’ 3, which can cause the brake to engage under certain circumstances. For example, if the elevator car 4 is travelling too quickly within the hoistway 6, or if a fault is detected with one of the components of the elevator system 2, the current flow path through the brake coil 18 can be interrupted, thereby causing the brake to close in response. This brings the elevator car 4 to a safe stop and preventing motion of the elevator car 4 until the issue is dealt with.

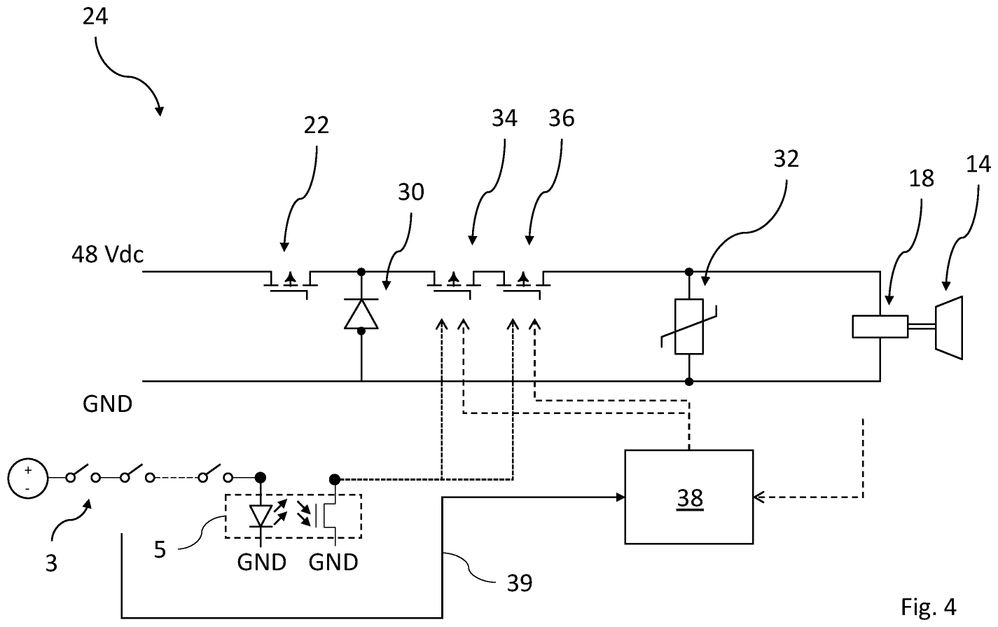

FIG. 3 is a circuit diagram of a prior art safety circuit 24. The current supply is provided by a 48 V DC voltage supply, e.g. from the drive, and is shown as the positive supply rail. A ground rail, GND, is also shown. In this arrangement, the drive switch 22 is provided by a MOSFET, connected in series between the voltage supply and the brake coil 18.

Also connected in series between the supply and the brake coil 18, downstream of the switch 22, are a pair of relays 26, 28. These relays 26, 28 act as the actuators of the safety circuit, the operation of which depends on the safety chain 3 such that if any of the switches of the safety chain 5 are opened in response to a fault, e.g. of the types outlined above, the relays 26, 28 should open (if working correctly). The reason for having two actuator relays 26, 28 is that they provide redundancy for additional safety. If either (or both) relays 26, 28 are opened, current flow through the brake coil 18 is prevented, thereby ‘dropping’ the braking element 14 to close the brake.

When current through the brake coil 18 is stopped, the induced magnetic field associated with the brake coil 18 ‘collapses’, which causes a spike of current. This current is dissipated using a flyback arrangement constructed from a flyback diode 30 connected in parallel with the brake coil 18, upstream of the relays 26, 28.

The diode 30 is arranged such that its anode is connected to ground GND, and its cathode is connected to the output of the switch 22.

A varistor 32 is also connected in parallel with the brake coil 18 and provides overcurrent protection. During normal operation, the varistor 32 does not conduct.

However, if there is a large spike in current, the varistor 32 begins to conduct, and dissipates the excess energy.

In order to check that the safety circuit is able to cause the brake to close, it is generally important to regularly check operation of the actuators, i.e. the relays 26, 28. This is done when the elevator car 4 is at a standstill, i.e. when it is not moving.

Due to the way relays are constructed, it is possible to use the ‘back contacts’ of the relays 26, 28 to check that they are operating as intended.

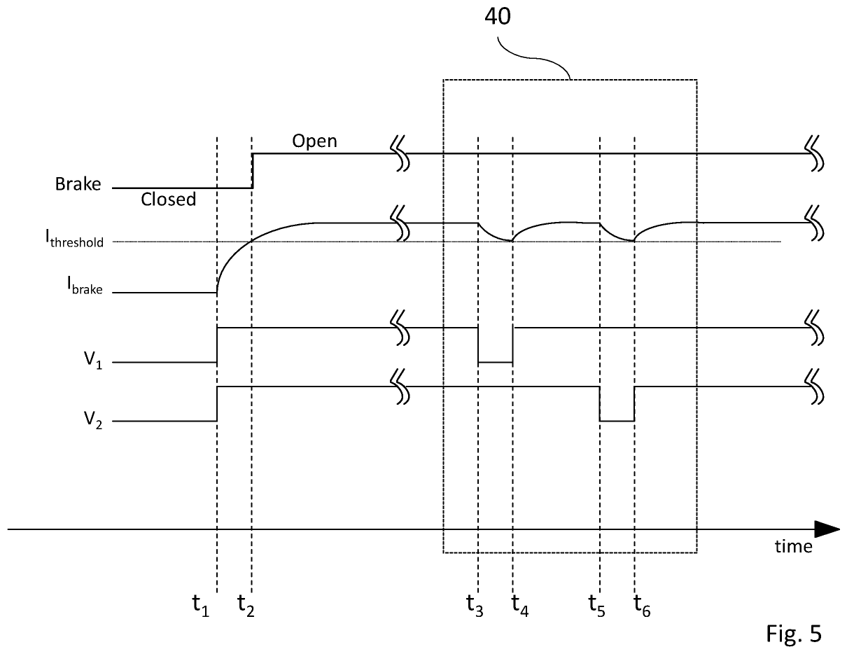

FIG. 4 is a circuit diagram of a safety circuit in accordance with an example of the present disclosure, where elements having like reference numerals correspond in form and function to those described above as appropriate.

Unlike the prior art system of FIG. 3, the actuators are implemented using a pair of transistors 34, 36, which in this example are a pair of MOSFETs, where the gate terminals of these actuator transistors 34, 36 are coupled to the output of the safety chain 3 via an optocoupler 5 (though some other type of suitable coupler could be used instead as appropriate). However, the operation of these actuator transistors 34, 36 cannot be tested when the elevator car 4 is stopped, i.e. when no current is flowing through the actuator transistors 34, 36 due to the switch 22 being open. It will be appreciated that more than two transistors could be used, however two is generally accepted to be sufficient for redundancy requirements.

The actuator transistors 34, 36 used in this example conduct when the voltages V₁, V₂ at their respective gate terminals (as determined by the safety chain 3 and controller 38, as outlined below) is high, and do not conduct when the respective voltage V₁, V₂ is low. It will, of course, be appreciated that transistors having the opposite behaviour (i.e. active low) could be used with suitable modifications to the circuit.

The system in FIG. 4 is advantageously arranged such that operation of the actuator transistors 34, 36 can be tested when the elevator car 4 is in motion, without needing to interrupt motion by fully closing the brake. This is achieved using a ‘partial stroke’ test, as outlined in further detail below.

The partial stroke test is conducted by a controller 38, which provides control voltages V₁, V₂ to the respective gate terminals of the actuator transistors 34, 36. The controller 38 also monitors (either directly or indirectly) the current I_{brake} in the brake coil 18. There are several different methods for monitoring this current, some of which are described in further detail below. The controller 38 receives status information from the safety chain 3, e.g. via a controller area network (CAN) bus 39, where the controller 38 uses this status information when determining when to perform the test operation outlined below.

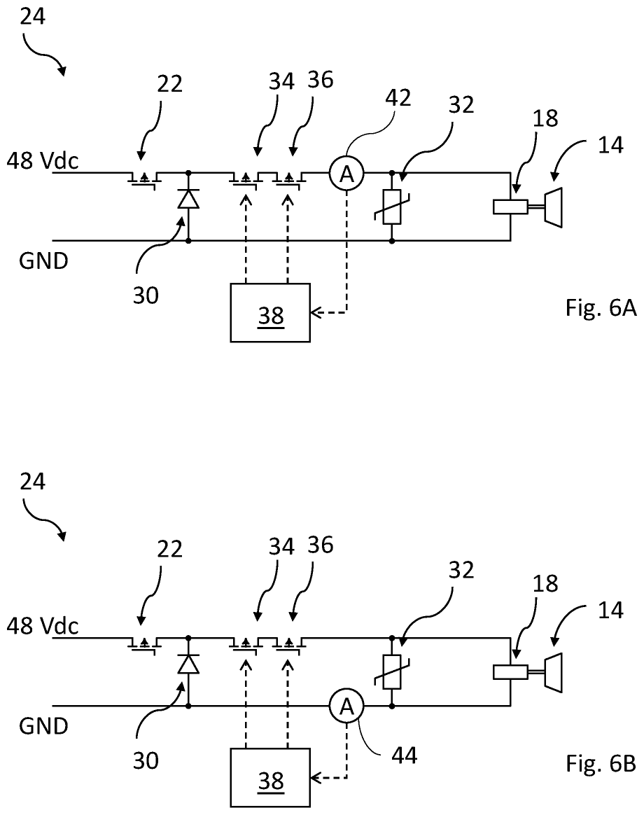

FIG. 5 is a timing diagram illustrating the partial stroke test operation of the safety circuit of FIG. 4. Initially, the voltages V₁, V₂ applied to the respective gate terminals of the actuator transistors 34, 36 are low, resulting in the actuator transistors 34, 36 being off. As the actuator transistors 34, 36 are off, no current I_{brake} flows through the brake coil 18, and thus the brake remains closed. Throughout this test, all of the switches of the safety chain 3 are closed, i.e. there are not currently any fault conditions and the elevator otherwise operates normally.

At an initial time t₁, the voltages V₁, V₂ applied to the respective gate terminals of the actuator transistors 34, 36 are set high, allowing current I_{brake} to flow through the brake coil 18. The brake current I_{brake} starts to ramp up.

At t₂, the brake current I_{brake} is sufficiently large that it exceeds the current threshold I_{threshold} required in order to overcome the spring force and thereby open the brake. The brake current I_{brake} continues to increase for a short time until it reaches its maximum, steady state value.

During normal operation, i.e. while the elevator car 4 is in motion, a partial stroke test 40 can be carried out. The test 40 is carried out for each of the actuator transistors 34, 36 separately.

Firstly, at time t₃, the test of the first actuator transistor 34 is started. For the test, the voltage V₁ applied to the gate terminal of the actuator transistor 34 is set low for a very brief period, until t₄. The time between t₃ and t₄ is chosen such that, assuming proper operation of the actuator transistor 34, the brake current I_{brake} will drop, but not below the threshold I_{threshold}. This will generally depend on the components and dynamics of the system, but the period may be approximately 50 ms.

As can be seen in FIG. 5, the brake current I_{brake} drops between t₃ and t₄, where this drop in current is detected by the current monitor function of the controller 38. This test is deemed a success as it shows that the controller 38 can cause the brake to actuate, using the first actuator transistor 34, if it needs to, i.e. in response to one or more switches within the safety chain 3 opening.

At t₄, the voltage V₁ applied to the gate terminal of the actuator transistor 34 is set back to high. As the threshold current was not crossed, the brake remains open throughout the test, and thus motion of the elevator car 4 is not interrupted by carrying out the test.

Subsequently, the other actuator transistor 36 is tested in the same way, with the voltage V2 being ‘pulsed low’ between t₅ and t₆ (where the period between these may, again, be approximately 50 ms). As can be seen in FIG. 5, the brake current I_{brake} drops between t₅ and t₆, where this drop in current is detected by the controller 38 as before. This test is also deemed a success as it shows that the controller can cause the brake to actuate, using the second actuator transistor 36, if it needs to.

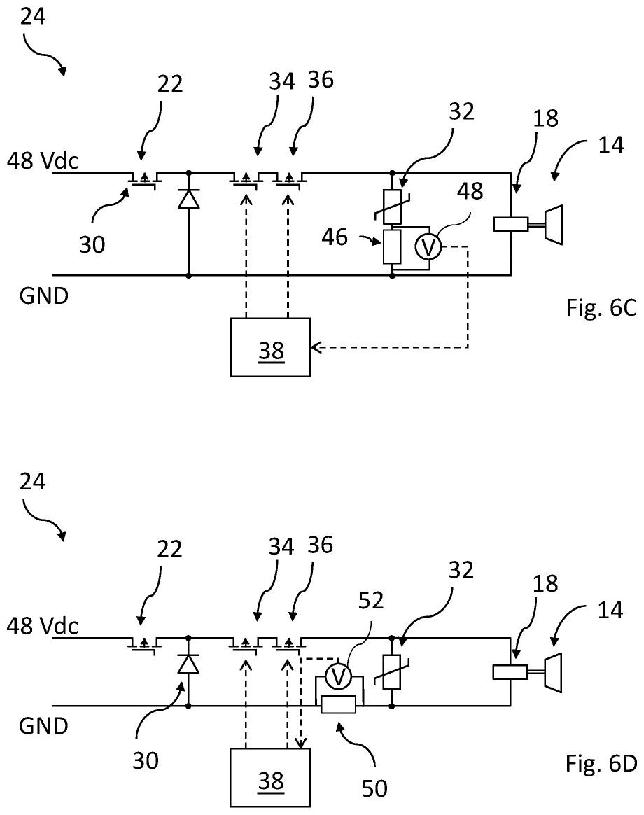

FIGS. 6A-D are circuit diagrams illustrating possible mechanisms for monitoring the current in the brake coil 18, where like reference numerals indicate like components to those described previously. For ease of illustration, the safety chain 3 and optocoupler 5 are omitted from FIGS. 6A-D for ease of illustration, however these would be included for normal operation, using the same structure and operation as outlined previously.

FIG. 6A shows an arrangement in which the current is monitored by a current monitor 42 connected in series along the positive supply rail, downstream of the actuator transistors 34, 36.

FIG. 6B shows an arrangement in which a current monitor 44 is connected in series along the ground rail, downstream of the brake coil 18 and varistor 32.

FIG. 6C shows an arrangement in which a fixed resistor 46 is connected in series with the varistor 32, and a voltage drop across the fixed resistor 46 is monitored by a voltage monitor 48 connected across the resistor 46.

FIG. 6D shows an arrangement in which a fixed resistor 50 is connected in series along the ground rail, downstream of the brake coil 18 and varistor 32. A voltage across the fixed resistor 50 is monitored by a voltage monitor 52 connected across the resistor 50.

One or more of the arrangements shown in FIGS. 6A-D can be used to provide information to the controller 38 regarding the current I_{brake} flowing through the brake coil 18. As outlined above, the controller 38 then uses this measure of the current I_{brake} to determine whether the actuator transistor 34, 36 under test is able to cause the current I_{brake} to drop, i.e. to cause the brake to close and thereby stop motion of the elevator car 4.

Thus, it will be appreciated by those skilled in the art that examples of the present disclosure provide an improved elevator system in which the elevator safety circuit utilises transistors, the proper operation of which is determined by a partial stroke test. This advantageously allows the use of transistors as the actuators that are coupled to and controlled by the safety chain in the safety circuit. This avoids the noise associated with relays while not requiring normal operation of the elevator system to be interrupted in order to test the safety circuit.

While specific examples of the disclosure have been described in detail, it will be appreciated by those skilled in the art that the examples described in detail are not limiting on the scope of the disclosure.

What is claimed is:

1. An elevator system comprising:
a brake including a braking element and an electromagnetic brake coil, said brake being arranged to pass an electrical current from a supply to the brake coil via a current flow path, said brake being arranged to apply a mechanical bias force to operate the braking element in a closed position when a magnitude of the electrical current is less than a threshold value, wherein the electromagnetic coil produces an electromagnetic force that overcomes said bias force to operate the braking element in an open position when the electrical current is equal to or greater than the threshold value;
an actuator transistor arranged in series along the current flow path between the supply and the brake coil, said actuator transistor having an enabled mode in which it allows passage of the electrical current, and a disabled mode in which it interrupts the current flow path thereby preventing passage of the electrical current; and
a controller arranged to carry out a test operation when the braking element is in the open position, wherein the test operation comprises operating the actuator transistor in its disabled mode for a time period, monitoring the electrical current through the brake coil, and determining whether the magnitude of the electrical current reduces during said time period;
wherein the time period is selected such that the magnitude of the electrical current remains greater than the threshold current during said time period.

2. The elevator system of claim 1, further comprising a safety chain including a plurality of safety chain switches arranged in series, wherein a gate terminal of the actuator transistor is connected to an output of the safety chain, said elevator system being arranged such that when one or more of the safety chain switches is open, the actuator transistor is operated in its disabled mode.

3. The elevator system of claim 1, comprising a plurality of actuator transistors provided in series along the current flow path between the supply and the brake coil, wherein the controller is arranged to carry out the test operation for each of the plurality of actuator transistors sequentially.

4. The elevator system of claim 1, wherein the controller is connected to a current monitor arranged to monitor the electrical current through the brake coil.

5. The elevator system of claim 1, wherein the controller is connected to a current monitor arranged to monitor a current at the output of the actuator transistor(s).

6. The elevator system of claim 1, wherein the controller is connected to a current monitor arranged to monitor a current along a return current path.

7. The elevator system of claim 1, wherein the controller is connected to a voltage monitor arranged to monitor a voltage across the brake coil, wherein the controller is arranged to determine the electrical current through the brake coil from said voltage.

8. The elevator system of claim 7, wherein a fixed resistor is connected in parallel across the brake coil, wherein the voltage monitor monitors the voltage across said fixed resistor.

9. The elevator system of claim 1, comprising a varistor connected in parallel across the brake coil.

10. The elevator system of claim 1, arranged such that the supply is connected to the brake coil via first and second conductors, wherein the actuator transistor(s) are connected in series along the first conductor.

11. The elevator system of claim 10, comprising a freewheel diode connected between the first and second conductors, such that its anode is connected to the second conductor, and its cathode is connected to the first conductor.

12. The elevator system of claim 1, wherein the supply comprises a DC power supply such that the electrical current is a direct current, optionally wherein the DC power supply supplies a DC voltage of at least 10 V, optionally at least 20 V, preferably at least 30 V, and more preferably at least 40 V, optionally wherein the DC power supply supplies a DC voltage of 48 V.

13. The elevator system of claim 1, comprising a drive switch connected between the supply and the actuator transistor(s), optionally wherein the drive switch comprises a MOSFET.

14. An elevator safety circuit for an elevator system, the elevator safety circuit comprising:
an input arranged to receive an electrical current from a supply;
an output arranged to selectively provide the electrical current to an electromagnetic brake coil via a current flow path;
an actuator transistor arranged in series along the current flow path between the input and the output, said actuator transistor having an enabled mode in which it allows passage of the electrical current, and a disabled mode in which it interrupts the current flow path thereby preventing passage of the electrical current; and
a controller arranged to carry out a test operation when the braking element is in the open position, wherein the test operation comprises operating the actuator transistor in its disabled mode for a time period, monitoring the electrical current through the brake coil, and determining whether the magnitude of the electrical current reduces during said time period;
wherein the time period is selected such that the magnitude of the electrical current remains greater than the threshold current during said time period.

15. A method of testing a brake in an elevator system, wherein:
the brake includes a braking element and an electromagnetic brake coil, said brake being arranged to pass an electrical current from a supply to the brake coil via a current flow path, said brake being arranged to apply a mechanical bias force to operate the braking element in a closed position when a magnitude of the electrical current is less than a threshold value, wherein the electromagnetic coil produces an electromagnetic force that overcomes said bias force to operate the braking element in an open position when the electrical current is equal to or greater than the threshold value; and
an actuator transistor is arranged in series along the current flow path between the supply and the brake coil, said actuator transistor having an enabled mode in which it allows passage of the electrical current, and a disabled mode in which it interrupts the current flow path thereby preventing passage of the electrical current;
the method comprising:
when the braking element is in the open position, operating the actuator transistor in its disabled mode for a time period;
monitoring the electrical current through the brake coil; and
determining whether the magnitude of the electrical current reduces during said time period;
wherein the time period is selected such that the magnitude of the electrical current remains greater than the threshold current during said time period.
